(19) United States
(12) Patent Application Publication
(10) Pub. No.: US 2008/0055905 A1
(43) Pub. Date: Mar. 6, 2008

(54) Ship-borne searchlight

(75) Inventor: Shin-Yung Chiu, Sindian City (TW)

Correspondence Address: BACON & THOMAS, PLLC, 625 SLATERS LANE, FOURTH FLOOR, ALEXANDRIA, VA, 22314, US

(73) Assignees: Shin-Yung Chiu, Sindian City (TW); DAVID WORSHAM, Alabaster, AL (US)

(21) Appl. No.: 11/511,282

(22) Filed: Aug. 29, 2006

(51) Int. Cl. F21V 33/00

(52) U.S. Cl. 362/253

(57) ABSTRACT

A ship-borne searchlight comprising a lamp housing, a reversible motor installed on the lamp housing, a movable cover pivotally connected to the lamp housing and a lamp mounted on back side of the movable cover, wherein the movable cover has a sector block formed on its back side and a ring gear further formed on lower circumference of the sector block to engage a driving gear inside the lamp housing, so that by controlling the reversible motor the driving gear shall rotate in clockwise or counter clockwise direction to enable a movement of open-up or close-down of the movable cover relative to the lamp housing to vary the direction of light beam of the lamp; particularly, when the ship-borne searchlight is not in use, the lamp shall be kept inside the lamp housing to save space taken up by the searchlight.

### BACKGROUND OF THE PRESENT INVENTION

1. Field of the Invention

The invention relates to a ship-borne searchlight, particularly the ship-borne searchlight having means for setting the searchlight in stored condition.

2. Description of the Prior Art

Normally, in order to ensure the safety of movement during night time, most of ships are equipped with searchlight for lighting the surrounding environment, and the light beam can be moved to aim at the desired place or corner.

However, the general structure for a conventional ship-borne searchlight is to have the searchlight fixed directly in a place outside the cabin, and there is no any means designed for the conventional searchlight to be easily set in stored condition when it is not in use. Therefore, the conventional searchlight installed on yacht or ship for lighting purpose has no advantage of saving the space for mounting the searchlight.

### SUMMARY OF THE INVENTION

Owing to the reason as described above, the major purpose of the invention is to provide a ship-borne searchlight which may be installed on yacht or ship for lighting purpose with the features of adjustable direction of light beam and may be easily set in stored condition to save the space taken up by the searchlight, which structure of the searchlight of the invention comprises a lamp housing, a reversible driving motor mounted on the lamp housing, a movable cover pivotally installed on the lamp housing and a lamp mounted on back side of the movable cover, wherein the movable cover further has a sector block formed on the back side which has a ring gear formed on the lower circumference, and the ring gear is arranged to engage a driving gear which is on the rotating shaft of the reversible driving motor, with this mechanism the movable cover can move relative to the lamp housing to generate the movement of close-down and open-up simply by control the reversible motor to rotate in clockwise and counter clockwise direction and to vary the direction of light beam. Besides, the inner side of the lamp housing has a lamp keeping cavity. When the searchlight is not in use the lamp can be kept in the lamp keeping cavity inside the lamp housing to save the space taken up by the searchlight.

The minor purpose of the invention is to provide a ship-borne searchlight with structure as described above, wherein the lamp housing is equipped with a limit switch which can be controlled by the sector block to connect or disconnect the power supplied to the lamp.

### BRIEF DESCRIPTION OF THE DRAWINGS

FIG. 1 is an illustrating drawing showing the application of a ship-borne searchlight of the invention on yacht or ship.

FIG. 2 is the three-dimensional structural drawing of the ship-borne searchlight of the invention.

FIG. 3 is an internal structural drawing of the searchlight of the invention.

FIG. 4 is a schematic drawing showing that a movable cover of the ship-borne searchlight of the invention shall be driven by a driving gear to generate the movement of open-up and close-down.

### DETAILED DESCRIPTION OF THE INVENTION

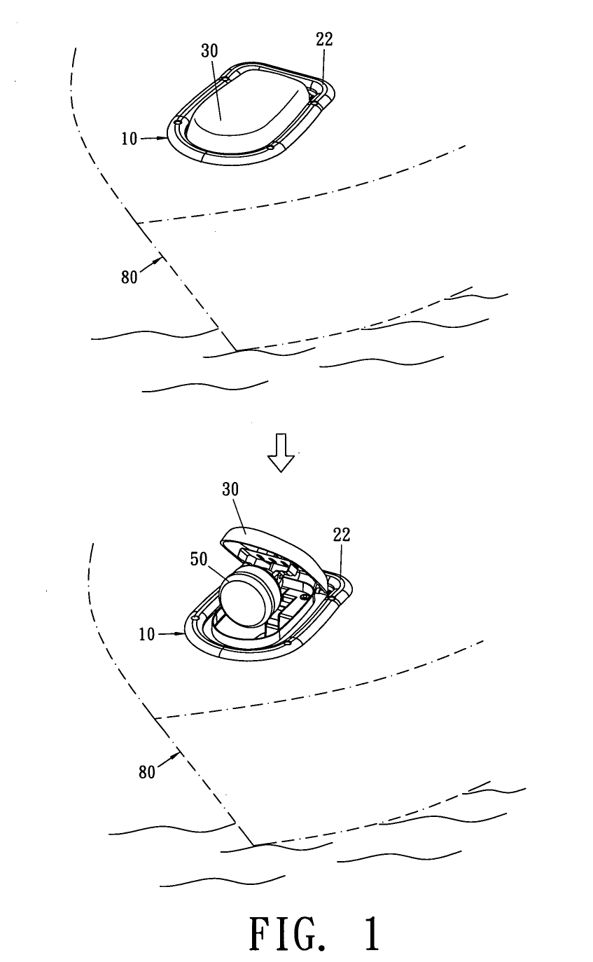

Referred to FIG. 1, a searchlight 10 of the present invention is installed on yacht or ship 80 for lighting purpose. Particularly, if the searchlight 10 is not in use, a lamp 50 of the searchlight 10 shall retract to a lamp keeping cavity 23 of the searchlight 10 for being set in stored condition that enables the advantage of saving installation space. When the yacht or ship 80 needs to use the searchlight 10 for lighting purpose the user can employ a remote controller (not shown in the drawing) to control and vary the direction of light beam of the searchlight 10 of the invention to have the light beam aimed at the place where illumination is required.

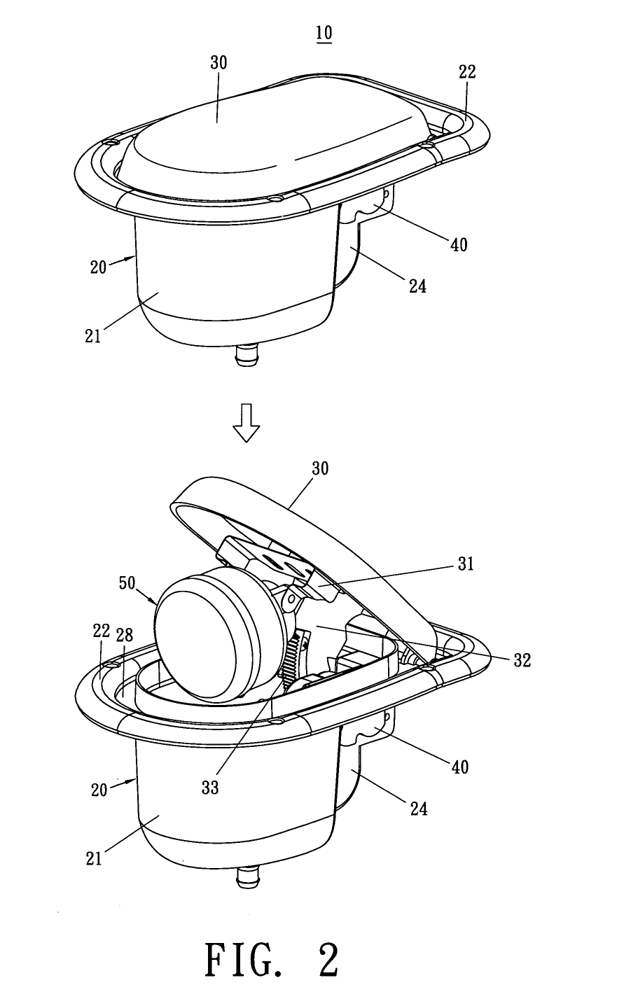

As shown in FIGS. 2 to 4, the structure of the searchlight 10 of the invention comprising a lamp housing 20, a movable cover 30 pivotally installed on the lamp housing 20, a driving unit 40 mounted on a thick-wall section 24 of the lamp housing 20 and a lamp 50 mounted on back side of the movable cover 30.

The basic structure of the lamp housing 20 is a box-shaped body 21 with its upper edge extended outwardly to form a flange portion 22 wherein a groove 28 is formed on the flange portion 22. When the movable cover 30 is closed down, and lie on the lamp housing 20, the edge of the movable cover 30 shall enter and engage the groove 28 to form tight fitting.

Besides, the interior of the box-shaped body 21 is also partitioned to have a lamp keeping cavity 23 by use of the thick-wall section 24 formed inside the box-shaped body 21, and the space of the lamp keeping cavity 23 of the lamp housing 20 is appropriate for accommodating the lamp 50.

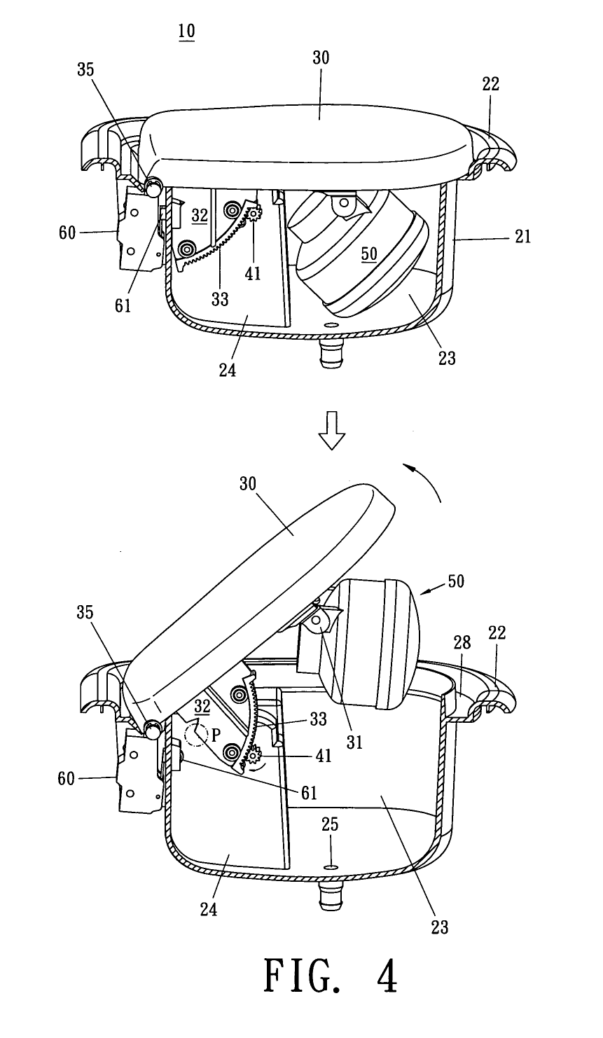

Referred to the FIG. 4, a penetrating hole 25 has formed on the bottom of box-shaped body 21 of the lamp housing 20 through which a power cord (not shown in the drawing) is connected to the aforesaid lamp 50 to form electrical connection. When the movable cover 30 generates the movement of open-up and close-down the power cord will not get entangled.

The driving unit 40 is installed on outer side of the thick-wall section 24 of the box-shaped body 21, and a driving gear 41 which extends into the box-shaped body 21. The driving unit 40 is a reversible motor with power cord connected to a manually operated remote controller (not shown in the drawing) through which the driving unit 40 shall be controlled to drive the driving gear 41 to rotate in clockwise or counter clockwise direction.

The movable cover 30 is mounted on the flange portion 22 of the lamp housing 20 by means of a pivotal shaft 35, and may generate a movement of close-down or open-up relative to the lamp housing 20 to rotate about the center line of the pivotal shaft 35.

On back side of the movable cover 30 has a connecting piece 31 and a sector block 32. The lamp 50 is mounted to the movable cover 30 by means of the connecting piece 31, and the sector block 32 has a curved surface formed on the lower circumference to form a ring gear 33.

Since the movable cover 30 is connected to the lamp housing 20 by means of pivotal shaft 35, the ring gear 33 of the sector block 32 shall rotate about the center line of the pivotal shaft 35, and the ring gear 33 of the sector block 32 engages the driving gear 41 of the driving unit 40. Therefore, when the driving gear 41 of the driving unit 40 rotates in clockwise or counter clockwise direction, the movable cover 30 will move to generate the movement of open-up or close-down.

As shown in FIGS. 1 to 4, the flange portion 22 of the lamp housing 20 of the searchlight 10 of the invention is fixed on the yacht or ship 80. When the movable cover 30 of the searchlight 10 is driven by the driving gear 41 to rotate and engage to the groove 28 of the flange portion 22 of the lamp housing 20, the movable cover 30 will carry the lamp 50 to move downwardly into the lamp keeping cavity 23 of the lamp housing 20 so that the lamp 50 shall be kept inside the lamp keeping cavity 23 and set in stored-up condition.

Whereas, when the movable cover 30 is driven by the driving gear 41 to rotate in open-up direction relative to the flange portion 22 of the lamp housing 20, the lamp 50 is carried by the movable cover 30 to move away from the lamp keeping cavity 23 of the lamp housing 20 until reaching the position where the lamp 50 is appropriate for generating the function of illumination. With this arrangement the angle of light beam of the searchlight 10 of the invention shall be varied and controlled.

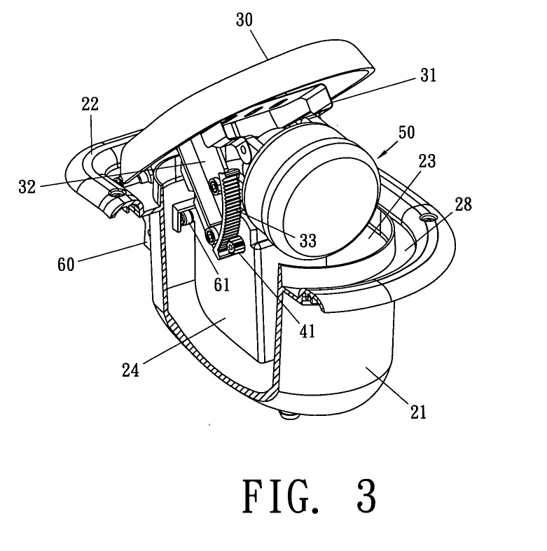

FIGS. 3 and 4 both illustrate another example of embodiment of the searchlight 10 of the invention which equipped with a limit switch 60 which for setting the power line of the lamp 50 in connecting and disconnecting condition.

For example, when a user of the searchlight 10 is to control the movable cover 30 by means of a manually operated remote controller, and if the movable cover 30 reaches the predetermined position, the pressing surface P as shown in FIG. 4 will press the trigger 61 of the limit switch 60 to disconnect the power line of the lamp 50 so that the lamp 50 is automatically turned off; whereas when the user is to control the movable cover 30 by means of a manually operated remote controller to let the movable cover 30 move up reaching the predetermined position, the trigger 61 is released, and the power line of lamp 20 is restored to connecting condition, and the lamp is turned on automatically.

However, the examples illustrated above are only the preferred embodiment of the invention, any partial change or modification without departing from the spirit of the present invention by employing the knowledge which is apparent to those skilled in the art shall still be covered by the appended claims of the invention.

What is claimed is:

1. A ship-borne searchlight comprising a lamp housing, a movable cover pivotally connected to the lamp housing, a reversible motor mounted on the lamp housing and a lamp mounted on back side of the movable cover characterized in that;
the lamp housing is a box-shaped body with its upper edge extended outwardly to form a flange portion, and the box-shaped body has a thick-wall section and a lamp keeping cavity formed inside, wherein the space of the lamp keeping cavity is arranged appropriately for accommodating the lamp;
the movable cover by using a pivotal shaft is pivotally connected to the flange portion of the lamp housing and shall move in the manner of open-up and close-down relative to the lamp housing; on back side of the movable cover has a connecting piece to connect the lamp and a sector block having a ring gear formed on its lower circumference which shall rotate about the center line of the pivotal shaft of the movable cover;
the reversible motor is installed on outer side of the thick-wall section of the box-shaped body and has a driving shaft and a driving gear mounted on the driving shaft to engage the ring gear of the sector block of the movable cover.

2. The ship-borne searchlight as described in claim 1, wherein the flange portion of the lamp housing has a groove for engaging the edge of the movable cover.

3. The ship-borne searchlight as described in claim 1, wherein the box-shaped body of the lamp housing is equipped with a limit switch, and the sector block of the movable cover is to control the limit switch to have the lamp turned on or off automatically.

4. The ship-borne searchlight as described in claim 2, wherein the box-shaped body of the lamp housing is equipped with a limit switch, and the sector block of the movable cover is to control the limit switch to have the lamp turned on or off automatically.
